(19) United States
(12) Patent Application Publication
(10) Pub. No.: US 2024/0131749 A1
(43) Pub. Date: Apr. 25, 2024

(54) CONCRETE SAW WITH CUTTING ENCLOSURE AND DUST COLLECTION SYSTEM

(71) Applicants: Tim Jenkins, Columbia Station, OH (US); Kyle G. Jenkins, Columbia Station, OH (US)

(72) Inventors: Tim Jenkins, Columbia Station, OH (US); Kyle G. Jenkins, Columbia Station, OH (US)

(21) Appl. No.: 18/319,580

(22) Filed: May 17, 2023

Related U.S. Application Data
(60) Provisional application No. 63/418,656, filed on Oct. 24, 2022.

(51) Int. Cl. B28D 7/02; B28D 1/04

(52) U.S. Cl. CPC B28D 7/02; B28D 1/045

(57) ABSTRACT

Various concrete cutting devices using a cutting enclosure and dust collection system are described. The system generally includes a housing, a door releasably secured to the housing, a cutting blade within an interior of the housing, at least one baffle within the housing interior, a vacuum port, and a blade sight window in the door. Also described are vertically positionable and optionally biased skid plates associated with the housing and blade.

### FIELD

The present subject matter relates to concrete cutting tools, and particularly concrete cutting saws having a unique cutting enclosure and dust and debris collection system. The present subject matter also relates to methods of cutting and/or forming joints in concrete using the tools and saws described herein.

### BACKGROUND

A disadvantage associated with concrete cutting saws is the large amount of dust and debris resulting from a typical cutting operation. Such dust and debris can be particularly problematic when cutting indoors. Although dust collecting assemblies are known, their use often obscures an operator's view of the cutting area, and particularly blade position.

Recently, a practice gaining popularity in the concrete industry is “green cutting” or “early entry.” This refers to forming cuts or crack control joints in freshly poured concrete and prior to the concrete fully curing. In many green cutting operations, cutting is performed as recently as only several hours after pouring. This practice is beneficial as it enables cutting and forming crack lines to be performed in the same job phase as the concrete pour.

With the advent of green concrete cutting saws, the use of water as a cooling agent to the blade can not be used. This is due to the concrete not being fully cured, and thus additional water would weaken the uncured concrete. As a result, currently known green concrete saws fully enclose the blade to reduce the escape of dust and debris generated from the cutting process. As a consequence, a fully enclosed blade prevents an operator from viewing the blade while cutting.

Related to this is an increased risk of chipping the green concrete which has not yet fully cured or hardened. In order to reduce the potential for chipping, it is important for an operator to be able to view the region of concrete undergoing cutting by a blade. It is also beneficial for the operator to maintain a desired blade position and orientation relative to the cut surface of the concrete during a cutting operation. Improper positioning of the blade can cause chipping or other damage to uncured green concrete.

As a result of the large amount of dust and debris generated from cutting, typically, the blade and particularly the region of concrete undergoing cutting is not visible to an operator. Furthermore, since the blade and cutting region is obscured from view as a result of copious amounts of dust and debris, maintaining blade position and orientation becomes problematic.

In view of these and other concerns, a need exists for an improved cutting tool.

### SUMMARY

The difficulties and drawbacks associated with previous approaches are addressed in the present subject matter as follows.

In one aspect, the present subject matter provides a concrete saw cutting enclosure and dust collection system comprising a dust enclosure housing defining an interior region and entryway providing access to the interior region. The system also comprises a door releasably secured to the housing and upon securement thereto generally covering the entryway. The system further comprises a rotary cutting blade at least partially disposed within the interior region of the housing. The blade defines an outer face and an oppositely directed inner face. The system additionally comprises at least one baffle positioned within the interior region of the housing and extending along at least one of the inner face and the outer face of the blade. The system also comprises a vacuum port on at least one of the door and the housing providing airflow communication with the interior region of the enclosure. The door defines a blade sight window enabling viewing of a portion of the blade disposed within the interior region of the housing, through the door.

In another aspect, the present subject matter provides a concrete saw cutting enclosure and dust collection system comprising a dust enclosure housing having an interior region. The system also comprises a rotary cutting blade positioned within the interior region of the housing. The system further comprises a door releasably attached to the housing. The door defines a blade sight window for providing viewing of at least a portion of the blade. The system further comprises at least one baffle disposed within the interior region of the housing and alongside the blade. And, the system comprises a vertically positionable skid plate disposed along a lower region of the housing. The skid plate is selectively positionable relative to the blade.

In still another aspect, the present subject matter provides a concrete saw comprising a base unit including at least one wheel. The saw also comprises a handle assembly secured to the base unit. The saw additionally comprises a rotary power source. And, the saw comprises a cutting enclosure and dust collection system including a housing defining an interior region, a door releasably attached to the housing, a rotary cutting blade in operable engagement with the rotary power source, and at least one baffle disposed within the interior region of the housing alongside the blade.

In yet another aspect, the present subject matter provides a method for cutting green concrete. The method comprises providing a concrete saw having a cutting enclosure and dust collection system. The method also comprises positioning the concrete saw such that a blade of the saw is aligned with a line or joint to be cut in the green concrete. The method also comprises actuating the saw so that the blade is rotating at a desired cutting speed. The rotating blade is contacted with the green concrete along the line or joint to be cut. The method also comprises moving the concrete saw along the line to be cut while the rotating blade contacts and cuts the green concrete.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a perspective view of an embodiment of a cutting enclosure and dust collection system in accordance with the present subject matter.

FIG. 2 is another perspective and partial sectional view of the cutting enclosure and dust collection system illustrated in FIG. 1, revealing an interior of a housing used in the system.

FIG. 3 is an outer side partial sectional view of the system of FIG. 1 illustrating a rotary blade, baffles, and a skid plate in accordance with the present subject matter.

FIG. 4 is another side partial sectional view of the system of FIG. 1 further illustrating aspects of the system.

FIG. 5 is another perspective view of the system shown in FIG. 1, without the rotary blade.

FIG. 6 is a perspective inner side view of the system shown in FIG. 5, free of the rotary blade.

FIG. 7 is a schematic first end view of the system shown in FIG. 1.

FIG. 8 is a schematic second end view opposite the first end, of the system of FIG. 1.

FIG. 9 is an exploded assembly view of the system of FIG. 1 showing the various components of the system.

FIG. 10 is a perspective view of a representative concrete saw utilizing the cutting enclosure and dust collection system.

### DETAILED DESCRIPTION OF THE EMBODIMENTS

The present subject matter provides a wide array of cutting tools that utilize a unique cutting enclosure and dust collection system. The system collects dust and debris from a cutting operation, enables viewing of a cutting operation by a user, and enables desired positioning of a blade and maintaining such position throughout a cutting operation. As described herein, the cutting enclosure and dust collection system is particularly beneficial for concrete saws in green cutting operations. The present subject matter, i.e., the concrete saws and cutting enclosures and dust collection systems described herein, are particularly directed to cutting green concrete. The present subject matter enables an operator to visually monitor and assess cutting while maintaining excellent dust control. The term “green concrete” as used herein refers to concrete that has set but has not hardened completely. Typically, such a state is exhibited by concrete from 1 to 8 hours after a pour, and more particularly from 1 to 3 hours after a pour. The cutting enclosure and dust collection system can be used in nearly any concrete saw having a powered rotary blade that is incorporated in a wheeled base. The cutting tools include one or more handles positioned for an operator typically standing or walking in front or behind the wheeled cutting tool. The cutting tools include provisions for collecting dust and debris resulting from a cutting operation.

The cutting devices and assemblies can be used for cutting an assortment of materials including concrete, masonry materials, and tile, for example. In many versions of the present subject matter, the cutting devices and systems as described herein are particularly adapted for cutting concrete. However, it will be understood that the present subject matter systems and devices are not limited to cutting concrete and instead, include a wide array of other applications and uses.

As noted, the cutting tools and related devices include provisions for collecting dust and debris. One or more dust collection tube(s) or vacuum ports is provided in the system at which a reservoir can be connected. In certain applications, it may be beneficial to attach a vacuum source at the dust collection tube, or in communication therewith, to promote or facilitate such collection of dust and debris. These and other aspects of the present subject matter are described herein and depicted in the referenced drawings.

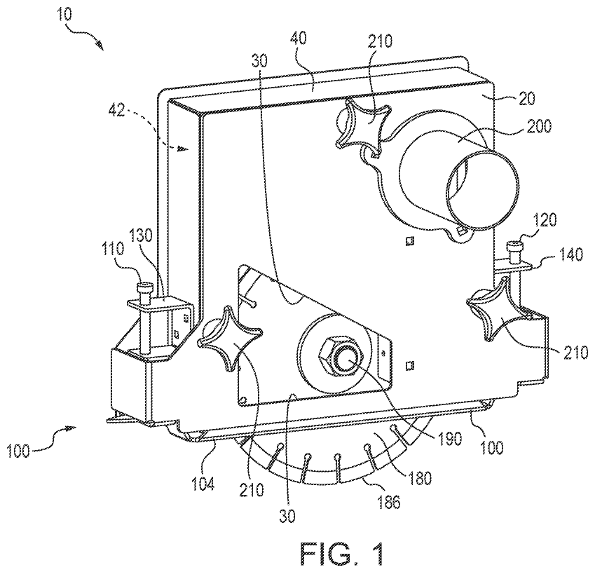

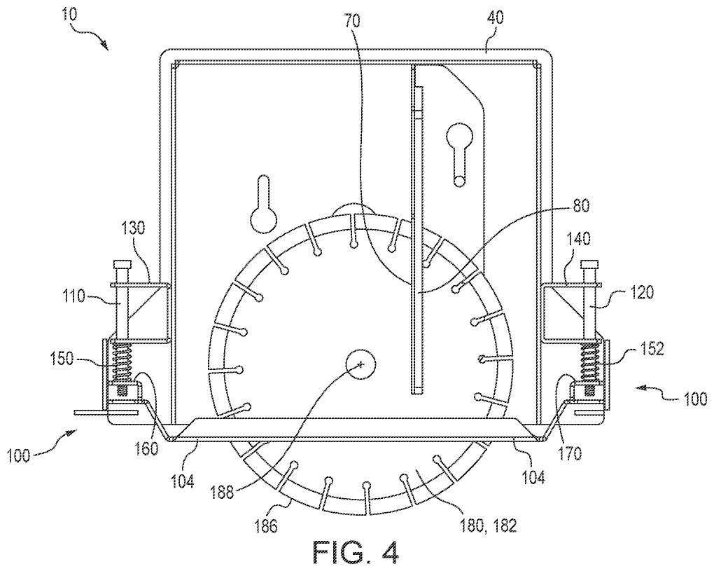

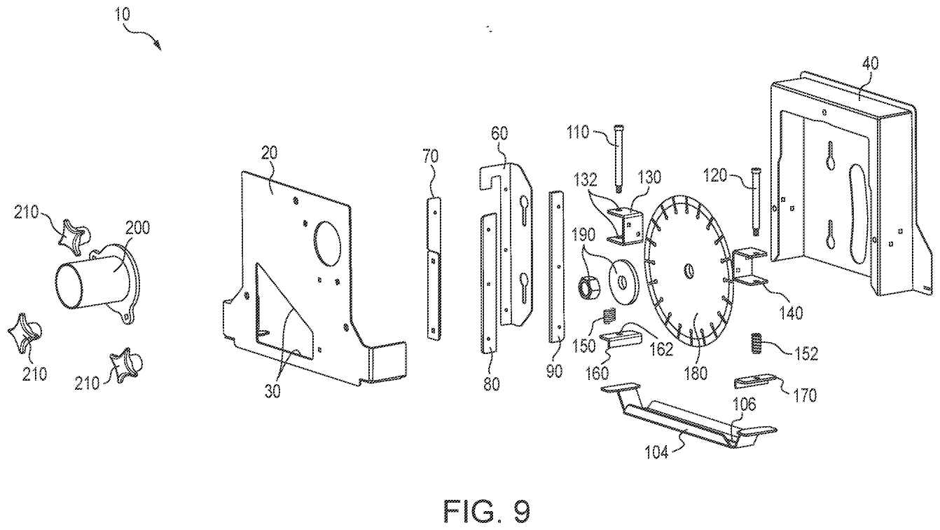

FIGS. 1-4 and 7-9 illustrate an embodiment of a cutting enclosure and dust collection system 10 in accordance with the present subject matter. The system 10 comprises a dust enclosure housing 40 and a removable dust enclosure door 20. Although a door is described, it will be understood that an equivalent panel or plate could be used. The housing 40 defines an entryway 44 and an interior region 42 described in greater detail herein. The door 20 or panel is typically releasably detachable from the housing 40. The door 20 is positioned to cover the entryway 44 of the housing 40 and thereby govern access to the interior 42 of the housing 40. In the particular embodiment depicted, one or more fasteners 210 can be used to releasably affix the door 20 to the housing 40. Upon release and/or removal of the fastener(s) 210, the door 20 can be separated from the housing 40 to access the interior of the housing 40. The present subject matter includes configurations in which the door 20 is hingedly connected to the housing 40 so that the door 20 can be positioned to one or more open positions while remaining affixed to the housing 40. Upon opening of the door 20, the interior 42 of the housing 40 can be accessed.

Rotatably supported within the interior 42 of the housing 40 is a rotary cutting blade 180. Typically, a portion of the blade 180 extends beyond the interior 42 of the housing 40 and is exposed below the housing 40. The cutting blade 180 is engaged with a shaft (not shown) providing rotary power and rotation to the blade 180. Blade mounting hardware 190 secures the blade 180 to the shaft. The blade 180 defines an outer face 182 and an oppositely directed inner face 184. The blade 80 also defines a cutting edge 186, typically having a plurality of cutting teeth. Typically, a diamond cutting blade as known in the art can be used. However, the present subject matter includes other blade types and blade materials.

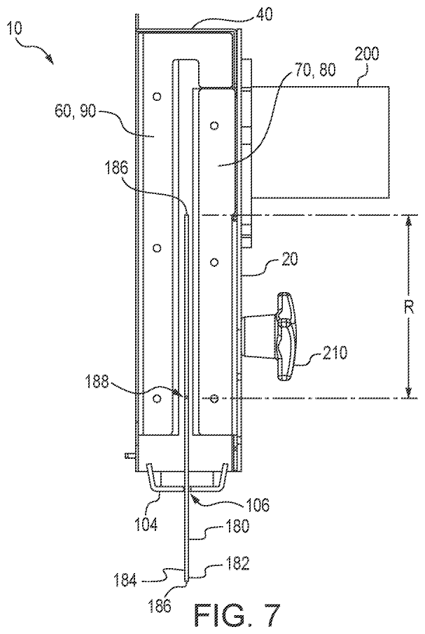

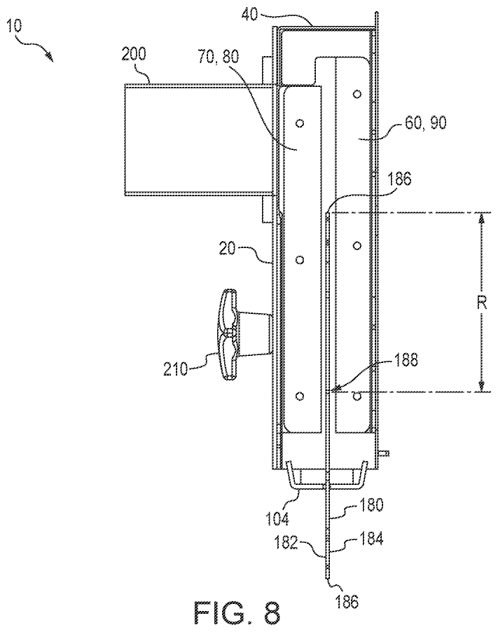

The system 10 also comprises at least one baffle positioned within the interior 42 of the housing 40 and extending alongside the blade 180. In the particular embodiment illustrated in the referenced figures, the system 10 comprises a plurality of baffles or baffle assemblies, such as a first baffle assembly in the form of an enclosure baffle seat 60 affixed to the housing 40 for supporting an enclosure baffle 90, and a second baffle assembly in the form of a door baffle seat 80 affixed to the door 20 for supporting a door baffle 80. Referring to FIGS. 7-8, the enclosure baffle seat 60 and enclosure baffle 90 retained thereto, are disposed along one face of the blade 180 such as the inner face 184. And the door baffle seat 70 and door baffle 80 retained thereto are disposed along an opposite face of the blade 180 such as the outer face 182. It will be understood that the present subject matter includes alternate arrangements and is not limited to the particular arrangement of baffle seats, baffles, and arrangement described herein. Additional aspects of the at least one baffle are described herein.

The system 10 additionally comprises one or more vacuum ports in airflow communication with the interior 42 of the housing 40. In the embodiment illustrated in the referenced figures, a vacuum port 200 is provided on the door 20. However, it will be understood that one or more vacuum port(s) can be located on the housing 40. It is also contemplated that multiple vacuum ports can be provided on the door 20 and on the enclosure 40.

Referring to FIG. 1, the system 10 also includes a blade sight window 30 defined in the door 20. The window 30 enables viewing of a portion of the blade 180 disposed within the interior region 42 of the housing 40, through the door 20. The window 30 enables an operator to visually inspect and assess a cutting operation through the door 20. The present subject matter also includes embodiments in which one or more viewing windows are provided in the housing 40 or, in both the housing 40 and the door 20. During a cutting operation, visibility through the window 30 is significantly enhanced due to the presence of one or more baffles positioned within the interior region 42 of the housing 40, and particularly along at least one face of the blade 180.

The present subject matter includes a wide array of locations, shapes and/or sizes for the window 30. In many embodiments, the window 30, defined in the door 20, is located such that at least a portion of the outer face 182 and the center of the blade 180 and likely the blade mounting hardware 190 can be viewed by an operator. The window 30 as defined in the door 20 can also extend to allow an outer edge of the blade 180 such as the cutting edge 186, to be visible to the operator. The window 30 can be sized relative to the total surface area of the outer face 182 of the blade 180, such that the area of the window 30 is at least 10%, in other embodiments at least 20%, and in still other embodiments at least 30% of the surface area of the outer face 182 of the blade 180. The present subject matter includes windows having areas less than 10% of the total surface area of a blade face, and greater than 30% of the total surface area of a blade face.

The window 30 can include a transparent or semi-transparent material covering the window 30. A wide array of materials can be used and particularly abrasion-resistant polymeric materials. It is also contemplated that suitable glass and crystalline materials could be used. The present subject matter also includes windows free of a covering material.

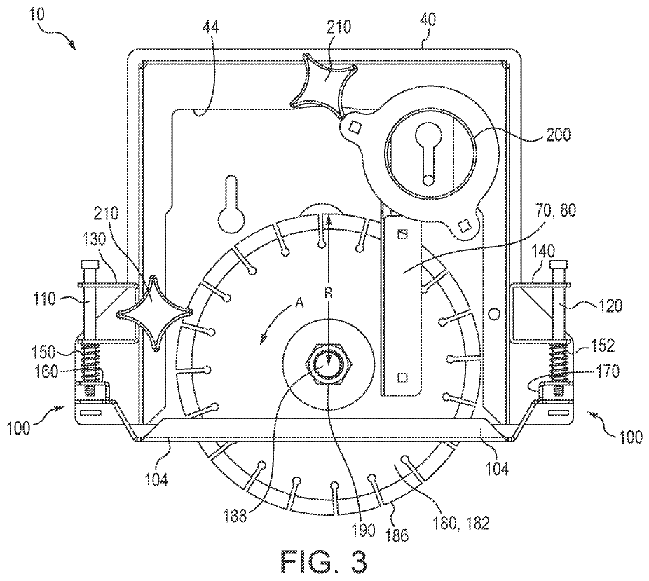

The present subject matter also provides particular orientations and positioning of the at least one baffle relative to a rotary cutting blade and to a vacuum port. Referring to FIG. 3, for a configuration in which the blade 180 rotates about an axis of rotation or center 188 in the direction of arrow A, the at least one baffle adjacent the door 20 such as the door baffle seat 70 and door baffle 80, are disposed below the vacuum port 200. Moreover, the door baffle seat 70, and the door baffle 80 extend alongside the outer face 182 of the blade 180, a distance greater than a radius R of the blade 180. Still further, the door baffle seat 70 and the door baffle 80 are located at a region along the outer face 182 of the blade 180 at which the blade is rotating upward toward the vacuum port 200. Corresponding orientations and positioning of the enclosure baffle seat 60 and enclosure baffle 90 alongside the inner face 184 of the blade 180 are also utilized. It will be further understood that the present subject matter includes a wide array of other arrangements and configurations and is not limited to the particular baffle locations described herein.

The baffles and baffle assemblies can be formed from a wide array of materials. In many embodiments, the baffles and baffle assemblies are formed from steel and can be coated with abrasion-resistant materials, such as a ceramic powder coating. In one version, the baffle seats are formed from steel and the baffles retained thereon are formed from a suitable polymeric material such as an acrylic material. In this version, the polymeric baffles can be replaced and provide less costly maintenance than periodically replacing an entire steel baffle assembly.

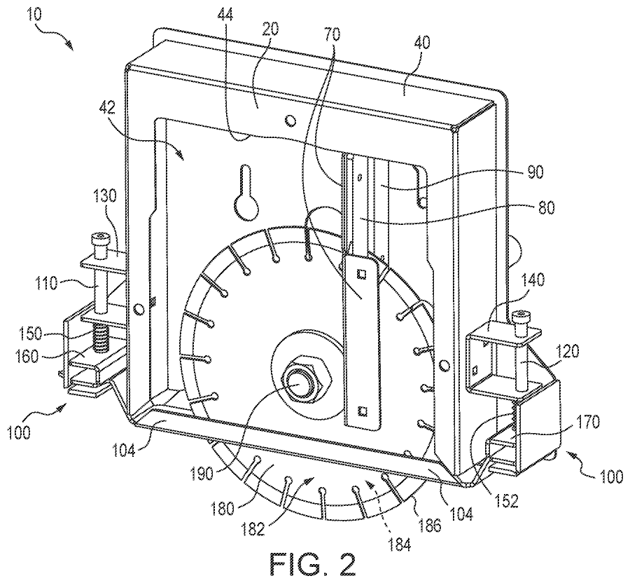

In particular versions, the concrete saw cutting enclosure and dust collection system also comprises a skid plate and particularly a biased skid plate assembly 100. The biased skid plate assembly 100 generally includes a skid plate 104 disposed along a lower region of the housing 40 and the door 20. The skid plate 104 defines a blade slot 106 through which the rotary blade 180 extends. The blade slot 106 typically extends along a longitudinal axis of the skid plate 104. The skid plate 104 is vertically positionable relative to the blade 180 and is retained along the lowermost region of the housing 40 and door 20 by a first support member 130 at one end of the housing 40, and a second support member 140 at another end of the housing 40. Vertical positioning assemblies of adjusters, biasing members, and stops associated with each of the support members provide for vertical positioning of the skid plate 104 relative to the housing 40 and the blade 180 rotatably supported therein. Specifically, referring to FIGS. 2-4 and 9, at one end of the housing, a first support member 130 is provided affixed to the housing 40. The support member 130 defines one or more apertures 132 for receiving a first force adjuster 110. Affixed to an end of the skid plate 104 and positioned below the support member 130 is a skid plate biasing stop 160. The biasing stop 160 defines an aperture 162 that is aligned with the aperture(s) 132 of the first support member 130 for receiving the first force adjuster 110. Preferably, a threaded end of the force adjuster 110 is threadedly engaged with the aperture 162. As best shown in FIG. 3, a first skid plate biasing member 150 is retained about the first force adjuster 110 and between the first support member 130 and the stop 160. Thus, upon assembly as shown in FIG. 3, a biasing force produced by the biasing member 150 is selectively adjusted by rotation of the force adjuster 110, to change a spacing between the first support member 130 and the biasing stop 160. The biasing member 150 urges the stop 160 and the skid plate 104 away from the blade 180 and the enclosure 40. A corresponding vertical positioning assembly is provided along an opposite end of the enclosure 40, such as including a second force adjuster 120, a second support member 140, a skid plate second biasing member 152, and a skid plate second biasing stop 170. It will be understood that the present subject matter includes a wide array of adjusting assemblies and biasing arrangements for providing selective positioning of the skid plate 104 relative to the blade 180 and enclosure 40. For example, the present subject matter includes an embodiment in which one or both of the vertical positioning assemblies are configured such that separate stop(s) 160, 170 are eliminated and instead, one or both ends of the skid plate 104 include a stop or stop member formed integrally therewith.

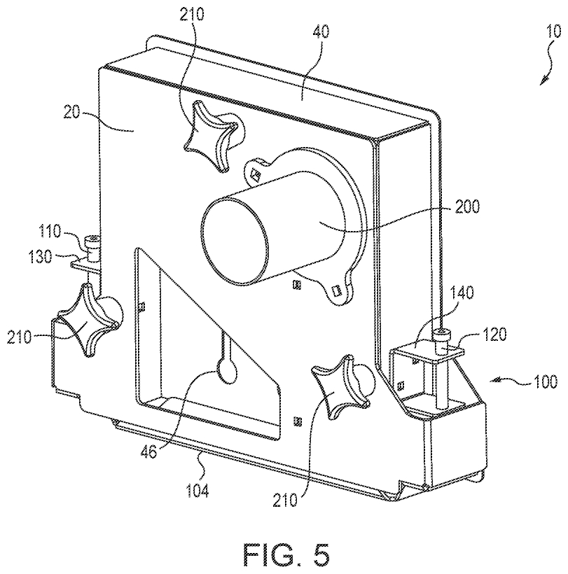

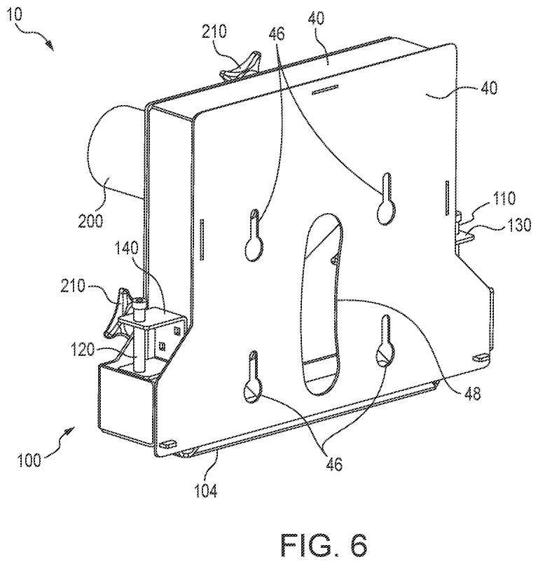

FIGS. 5-6 illustrate the enclosure 40 and various components of the system 10, without the rotary blade 180. The housing 40 can include one or more regions or apertures 46 at which the enclosure 40 is affixed or otherwise mounted on a concrete saw or similar device. The enclosure 40 can also define a passageway 48 for a shaft (not shown) for engagement with the blade and transfer of rotary power thereto. In certain versions, the shape of the passageway 48 is arcuate or at least elongate to allow change in position of the blade relative to the enclosure 40.

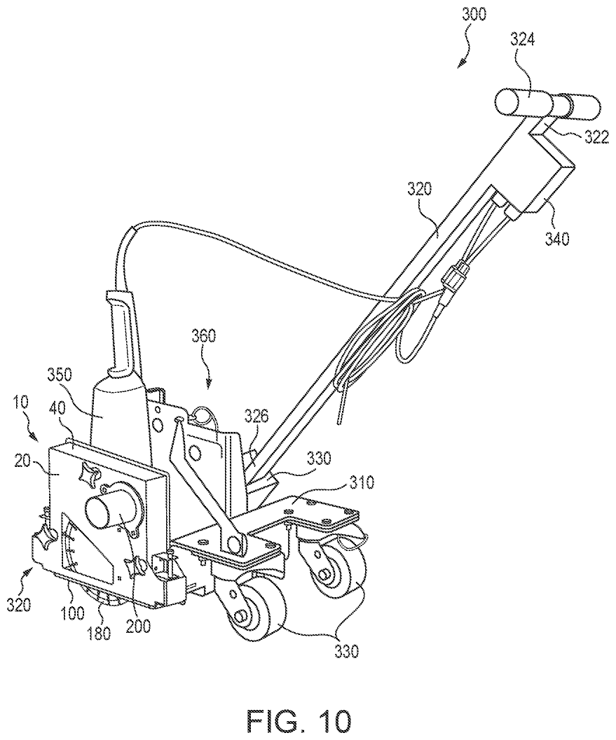

FIG. 10 illustrates a concrete saw 300 using a cutting enclosure and dust collection system 10 in accordance with the present subject matter. The concrete saw 300 comprises a base unit 310 or wheeled base as periodically referred to herein and a handle assembly 320 secured to the base 310. The concrete saw also comprises a cutting enclosure and dust collection system 10 as described herein secured to the wheeled base 310. The base 310 includes at least one wheel and in many embodiments, at least one front wheel 320 (not shown) and at least one rear wheel 330. The concrete saw 300 also comprises a rotary power source 350 such as an electric motor for rotatably powering a blade in the cutting enclosure and dust collection system 10.

The handle assembly 320 defines a distal end 322 typically having one or more grips or laterally extending members 324 for an operator to grasp, and an opposite proximal end 326 hingedly or movably affixed to the wheeled base 310. A pivoting handle base assembly 330 provides selective and adjustable positioning of the handle 320 relative to the wheeled base 310. In many embodiments, the pivoting handle base assembly 330 enables the handle 320 to be positioned toward a rear of the saw 300 up to 45° from vertical. And, in particular versions, the pivoting handle base assembly 330 enables the handle 320 to be positioned toward a front of the saw 300 up to 45° from vertical. In addition to enabling such positions for the handle 320, the pivoting handle base assembly 330 also enables selective securement or “locking” of the handle 320 in a desired angular position relative to the wheeled base 310. These features promote operator ease of use and enable an operator to stand or walk behind or in front of the cutting system during use. In many versions of the concrete saw 300, the handle assembly 320 includes a controller 340 having a power input, a power output, and one or more switches for controlling electrical power to the output. The concrete saw 300 can also comprise additional provisions such as but not limited to tracking provisions for promoting or assisting in maintaining a desired cut path. Blade speed control provisions can be included. In many cutting operations the blade rotates at a cutting speed within a range of from about 1,000 to about 6,000 RPM. Thus, it will be appreciated that the present subject matter is not limited to the particular embodiments described herein, and instead includes a variety of other configurations.

In many embodiments of the present subject matter, the concrete saw includes one or more vacuum system(s) 360 which are configured to collect such dust and debris which are generated or emitted from the cutting area, i.e., the interface between the cutting tool blade and surface or substrate being cut. In such embodiments, a collection hose extends between the vacuum port 200 of the system 10 and the vacuum system 360.

During operation of a concrete saw using the cutting enclosure and dust collection system 10, the saw can be operated such that the blade 180 rotates in an “up-cut” or a “down-cut.” In an up-cut blade rotation, a leading edge of a rotating blade pushes or otherwise displaces concrete material upward to a surface of the concrete, at which the skid plate smooths or “trowels” the surface. In some applications, this practice may be undesirable since the cut appears smooth, however the concrete aggregate is disturbed. A down-cut refers to an opposite direction of blade rotation and in some applications may be preferred because the potential for disturbing the concrete aggregate is reduced. The present subject matter includes both configurations and methods of green cutting.

The present subject matter also provides methods of cutting concrete and/or forming joints or recesses within concrete, and particularly green concrete. In a preferred method, a concrete saw including a cutting enclosure and dust collection system as described herein is provided. The concrete saw is positioned relative to the concrete and particularly such that the blade is aligned with a line or path to be cut in the concrete. The saw is activated so that the blade is rotating at a desired cutting speed. The rotating blade is then contacted with the concrete and particularly with the line to be cut therein. The saw is then moved or otherwise displaced along the line to be cut while the rotating blade contacts and cuts the concrete. Prior to and during cutting, an operator can view the blade through a blade sight window provided in the cutting enclosure and dust collection system. Providing visual confirmation and/or inspection of a cutting operation is highly beneficial and improves cut quality and consistency.

Many other benefits will no doubt become apparent from future application and development of this technology.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as described herein.

What is claimed is:

1. A concrete saw cutting enclosure and dust collection system comprising:
a dust enclosure housing defining an interior region and entryway providing access to the interior region;
a door releasably secured to the housing and upon securement thereto generally covering the entryway;
a rotary cutting blade at least partially disposed within the interior region of the housing, the blade defining an outer face and an oppositely directed inner face;
at least one baffle positioned within the interior region of the housing and extending along at least one of the inner face and the outer face of the blade;
a vacuum port on at least one of the door and the housing providing airflow communication with the interior region of the enclosure;
wherein the door defines a blade sight window enabling viewing of a portion of the blade disposed within the interior region of the housing, through the door.

2. The concrete saw cutting enclosure and dust collection system of claim 1 wherein the blade sight window is sized relative to the blade such that the area of the window is at least 10% of the surface area of the outer face of the blade.

3. The concrete saw cutting enclosure and dust collection system of claim 1 wherein the at least one baffle includes:
a first baffle assembly affixed to the housing and extending along the inner face of the blade;
a second baffle assembly affixed to the door and extending along the outer face of the blade.

4. The concrete saw cutting enclosure and dust collection system of claim 3 wherein the first baffle assembly includes an enclosure baffle seat affixed to the housing and an enclosure baffle supported and retained on the enclosure baffle seat.

5. The concrete saw cutting enclosure and dust collection system of claim 3 wherein the second baffle assembly includes a door baffle seat affixed to the door and a door baffle supported and retained on the door baffle seat.

6. The concrete saw cutting enclosure and dust collection system of claim 1 further comprising:
a skid plate disposed along a lower region of the housing and the door, the skid plate defining a blade slot through which the blade extends.

7. The concrete saw cutting enclosure and dust collection system of claim 6, further comprising:
at least one vertical positioning assembly including a support member secured to the housing, a stop secured to the skid plate, a force adjuster disposed between the support member and the stop, and a biasing member urging the stop and the skid plate away from the enclosure.

8. A concrete saw cutting enclosure and dust collection system comprising:
a dust enclosure housing having an interior region;
a rotary cutting blade positioned within the interior region of the housing;
a door releasably attached to the housing, the door defining a blade sight window for providing viewing of at least a portion of the blade;
at least one baffle disposed within the interior region of the housing and alongside the blade;
a vertically positionable skid plate disposed along a lower region of the housing, the skid plate being selectively positionable relative to the blade.

9. The concrete saw cutting enclosure and dust collection system of claim 8 further comprising:
a vacuum port on at least one of the door and the housing providing airflow communication with the interior region of the enclosure.

10. The concrete saw cutting enclosure and dust collection system of claim 8 wherein the blade sight window is sized relative to the blade such that the area of the window is at least 10% of the surface area of an outer face of the blade.

11. The concrete saw cutting enclosure and dust collection system of claim 8 wherein the at least one baffle includes:
a first baffle assembly affixed to the housing and extending along an inner face of the blade;
a second baffle assembly affixed to the door and extending along an outer face of the blade.

12. The concrete saw cutting enclosure and dust collection system of claim 11 wherein the first baffle assembly includes an enclosure baffle seat affixed to the housing and an enclosure baffle supported and retained on the enclosure baffle seat.

13. The concrete saw cutting enclosure and dust collection system of claim 11 wherein the second baffle assembly includes a door baffle seat affixed to the door and a door baffle supported and retained on the door baffle seat.

14. The concrete saw cutting enclosure and dust collection system of claim 8, further comprising:
at least one vertical positioning assembly including a support member secured to the housing, a stop secured to the skid plate, a force adjuster disposed between the support member and the stop, and a biasing member urging the stop and the skid plate away from the enclosure.

15. A concrete saw comprising:
a base unit including at least one wheel;
a handle assembly secured to the base unit;
a rotary power source;
a cutting enclosure and dust collection system including a housing defining an interior region, a door releasably attached to the housing, a rotary cutting blade in operable engagement with the rotary power source, and at least one baffle disposed within the interior region of the housing alongside the blade.

16. The concrete saw of claim 15 wherein the door defines a blade sight window enabling viewing of a portion of the blade within the interior region of the housing, through the door.

17. The concrete saw of claim 15 wherein the at least one baffle includes:
a first baffle assembly affixed to the housing and extending along an inner face of the blade;
a second baffle assembly affixed to the door and extending along an outer face of the blade.

18. The concrete saw of claim 15 further comprising:
a skid plate disposed along a lower region of the housing and the door, the skid plate defining a blade slot through which the blade extends.

19. The concrete saw of claim 18, further comprising:
at least one vertical positioning assembly including a support member secured to the housing, a stop secured to the skid plate, a force adjuster disposed between the support member and the stop, and a biasing member urging the stop and the skid plate away from the enclosure.

20. The concrete saw of claim 15 further comprising a vacuum source, wherein the cutting enclosure and dust collection system further includes a vacuum port in airflow communication with the vacuum source.

21. A method for cutting green concrete the method comprising:
providing a concrete saw including a base unit having at least one wheel, a handle assembly secured to the base unit, a rotary power source, and a cutting enclosure and dust collection system having a housing defining an interior region, a door releasably attached to the housing, a rotary cutting blade in operable engagement with the rotary power source, and at least one baffle disposed within the interior region of the housing alongside the blade;
positioning the concrete saw such that the blade is aligned with a line to be cut in green concrete;
actuating the concrete saw so that the blade is rotating at a desired cutting speed;
contacting the rotating blade with the green concrete along the line to be cut;
moving the concrete saw along the line to be cut while the rotating blade contacts and cuts the green concrete.

22. The method of claim 21 wherein the blade rotates relative to the green concrete in an up-cut configuration.

23. The method of claim 21 wherein the blade rotates relative to the green concrete in a down-cut configuration.

24. The method of claim 21 wherein the door of the cutting enclosure and dust collection system defines a blade sight window, whereby the method further comprises:
viewing the blade through the blade sight window.
